(19) United States
(12) Patent Application Publication
(10) Pub. No.: US 2022/0101209 A1
(43) Pub. Date: Mar. 31, 2022

(54) INFORMATION PROCESSING DEVICE, INFORMATION PROCESSING SYSTEM, AND METHOD OF INFORMATION PROCESSING

(71) Applicant: Toyota Jidosha Kabushiki Kaisha, Toyota-shi Aichi-ken (JP)

(72) Inventors: Kotaro Okabe, Ichikawa-shi Chiba-ken (JP); Tomo Sasaki, Toyota-shi Aichi-ken (JP); Koichi Suzuki, Miyoshi-shi Aichi-ken (JP); Genshi Kuno, Kasugai-shi Aichi-ken (JP); Koichi Hirano, Toyota-shi Aichi-ken (JP); Makoto Yamazaki, Nagoya-shi Aichi-ken (JP)

(73) Assignee: Toyota Jidosha Kabushiki Kaisha, Toyota-shi Aichi-ken (JP)

(21) Appl. No.: 17/406,647

(22) Filed: Aug. 19, 2021

(30) Foreign Application Priority Data
Sep. 29, 2020 (JP) 2020-164159

(51) Int. Cl. G06Q 10/02; G06Q 30/02

(52) U.S. Cl. CPC G06Q 10/02; G06Q 30/0284

(57) ABSTRACT

An information processing device includes a control unit. The control unit executes determination processing to determine whether or not a user will arrive at a first shop by a first time that is set based on a reservation start time of the first shop. When the control unit determines that the user will not arrive at the first shop by the first time, the control unit determines a cancellation fee based on movement information on the user.

### CROSS-REFERENCE TO RELATED APPLICATION

This application claims priority to Japanese Patent Application No. 2020-164159 filed on Sep. 29, 2020, incorporated herein by reference in its entirety.

### BACKGROUND

### 1. Technical Field

The present disclosure relates to an information processing device, an information processing system, and a method of information processing.

### 2. Description of Related Art

A system has conventionally been known which receives reservation information and credit information from a user, and maintains a cancellation fee collection request to a credit company when the user cancels a reservation after a cancellable period (see, for example, Japanese Unexamined Patent Application Publication No. 2019-169115.

### SUMMARY

The related art has room for improvement. For example, it may be inadequate to charge a uniform cancellation fee to the users who cancel their reservations after the cancellable period, depending on the cause why the reservations are cancelled.

An object of the present disclosure is to determine a cancellation fee corresponding to the cause why a reservation is cancelled.

An information processing device according to the present disclosure includes a control unit. The control unit is configured to execute determination processing to determine whether or not a user will arrive at a first shop by a first time that is set based on a reservation start time of the first shop, and determine a cancellation fee based on movement information on the user when it is determined that the user will not arrive at the first shop by the first time.

An information processing system according to the present disclosure includes: a vehicle; and an information processing device. The information processing device includes a control unit. The control unit is configured to execute determination processing to determine whether or not a user of the vehicle will arrive at a first shop by a first time that is set based on a reservation start time of the first shop, and determine a cancellation fee based on movement information on the user when it is determined that the user will not arrive at the first shop by the first time.

A method of information processing according to the present disclosure includes: an information processing device executing determination processing to determine whether or not a user will arrive at a first shop by a first time that is set based on a reservation start time of the first shop; and the information processing device determining a cancellation fee based on movement information on the user when it is determined that the user will not arrive at the first shop by the first time.

According to the present disclosure, it is possible to determine a cancellation fee corresponding to the cause why reservation is canceled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows configuration of an information processing system according to an embodiment of the present disclosure;

FIG. 2 is a block diagram showing detailed configuration of the information processing system shown in FIG. 1;

FIG. 3 shows reservation information for a first shop shown in FIG. 1;

FIG. 4 is a sequence diagram showing an example of the operation of the information processing system shown in FIG. 1; and

FIG. 5 is a sequence diagram showing an example of the operation of the information processing system shown in FIG. 1.

### DETAILED DESCRIPTION OF EMBODIMENTS

Embodiments of the present disclosure will be described hereinbelow with reference to the drawings. For the component members shown in the following drawings, like component members are denoted by like reference signs.

Configuration of Information Processing System

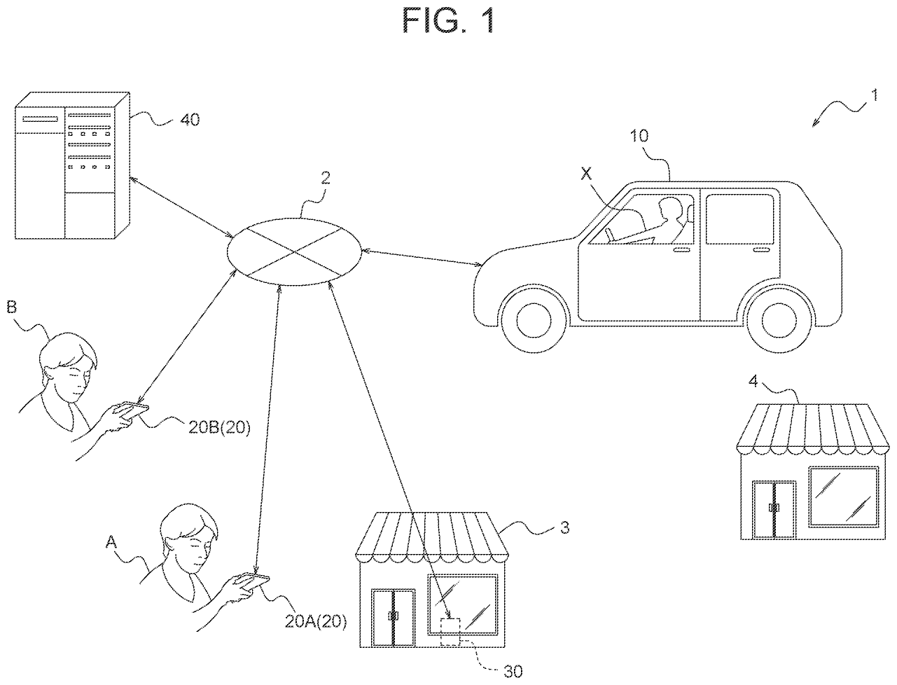

As shown in FIG. 1, an information processing system 1 according to an embodiment of the present disclosure includes a vehicle 10, terminal devices 20A, 20B, a terminal device 30, and an information processing device 40.

Hereinafter, the terminal device 20A and the terminal device 20B are collectively stated as “terminal device or devices 20” unless otherwise being distinguished from each other. FIG. 1 shows the information processing system 1 including two terminal devices 20. However, the information processing system 1 may include any number of terminal devices 20.

The vehicle 10, the terminal device 20, the terminal device 30, and the information processing device 40 can communicate with each other through a network 2. The network 2 may be any network including mobile communications networks, and the Internet.

The vehicle 10 can be driven by a user X. The user X has a reservation of one reservation frame provided by a first shop 3. The reservation frame may be associated with a reservation start time. The reservation start time is a reservation time when the user starts to use a service provided by the first shop 3. The reservation frame may be associated with a reservation end time. The reservation end time is a reservation time when the user ends the use of the service provided by the first shop 3. For example, the first shop 3 is a restaurant. The user X drives the vehicle 10, and goes to the first shop 3 by the vehicle 10.

The vehicle 10 may be any type of vehicle. Examples of the vehicle 10 include a gasoline vehicle, a diesel vehicle, a hybrid vehicle (HV), a plug-in hybrid vehicle (PHV), an electric vehicle (EV), or a fuel cell vehicle (FCV). Driving of the vehicle 10 may be automated in any levels. For example, the level of automation is any one of level 1 to level 5 defined by Society of Automotive Engineers (SAE). The vehicle 10 may be a vehicle dedicated for Mobility as a Service (MaaS).

The terminal device 20A may be used by a user A. The user A is waiting for cancellation of the reservation frame reserved by the user X. The terminal device 20B may be used by a user B. The terminal devices 20 may be any devices as long as they are connectable with the network 2. Examples of the terminal devices 20 may include portable telephones, smartphones, tablets, or personal computers (PCs).

The terminal device 30 may be used in the first shop 3. For example, the terminal device 30 is located in the first shop 3. The terminal device 30 may be any device as long as it is connectable with the network 2. Examples of the terminal device 30 may include a portable telephone, a smartphone, a tablet, or a personal computer.

As will be described later, when the information processing device 40 determines that the user X is unable to arrive at the first shop 3 by a first time, the information processing device 40 determines a cancellation fee based on movement information on the user X. The processing will be described later in detail.

The information processing device 40 may be configured to manage reservation for the first shop 3 or the like. The information processing device 40 may be a dedicated computer configured to function as a server, a general-purpose personal computer, a cloud computing system, or the like.

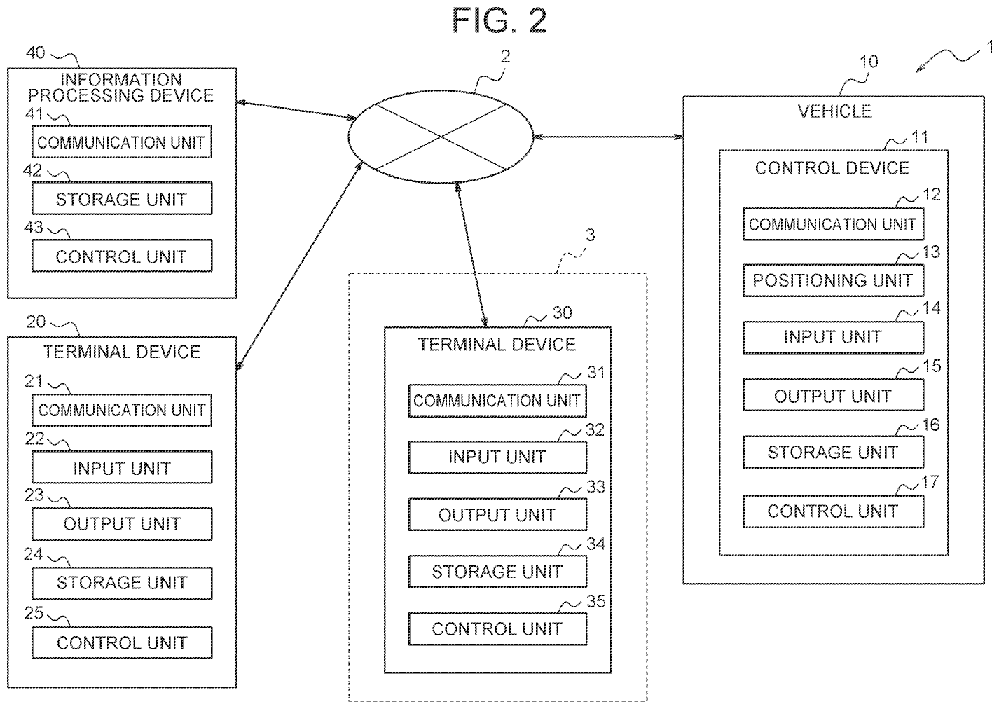

As shown in FIG. 2, the vehicle 10 includes a control device 11. For example, the control device 11 is a car navigation device. The control device 11 includes a communication unit 12, a positioning unit 13, an input unit 14, an output unit 15, a storage unit 16, and a control unit 17.

The communication unit 12 can be configured to include at least one communication module connectable with the network 2. The communication module conforms to mobile communications standards, such as long term evolution (LTE), 4th generation (4G), or 5th generation (5G) mobile communications standards.

The positioning unit 13 can acquire position information on the vehicle 10. The positioning unit 13 may be configured to include at least one reception module corresponding to a satellite positioning system. For example, the reception module is a reception module corresponding to a global positioning system (GPS). However, the reception module is not limited to this. The reception module may be a reception module corresponding to any global satellite positioning system.

The input unit 14 can receive input from a user. The input unit 14 can be configured to include at least one input interface that can receive input from a user. The input interface may be a physical key, an electrostatic capacitance key, a pointing device, a touchscreen integrally provided with a display, a microphone, or the like.

The output unit 15 can output data. The output unit 15 can be configured to include at least one output interface that can output data. The output interface may be a display, a speaker, or the like. The display may be a liquid crystal display (LCD), an electro luminescence (EL) display, or the like.

The storage unit 16 can be configured to include at least one semiconductor memory, at least one magnetic memory, at least one optical memory, or a combination of at least two types of these memories. For example, the semiconductor memory is a random access memory (RAM), a read only memory (ROM), or the like. For example, the RAM is a static random access memory (SRAM), a dynamic random access memory (DRAM), or the like. For example, the ROM is an electrically erasable programmable read only memory (EEPROM), or the like. The storage unit 16 may function as a main storage, an auxiliary storage, or a cache memory. The storage unit 16 stores data used for operation of the vehicle 10, and data obtained by operation of the vehicle 10.

The storage unit 16 stores, for example, road map information. The road map information includes, for example, identification information and position information on nodes representing intersections of roads, identification information and position information on links representing roads that connect the nodes, position information on shops, and the like. The identification information on nodes may be any information which can identify the nodes. The identification information on links may be any information which can identify the links. The storage unit 16 store, for example, the identification information on the user X. The identification information on the user X may be any information which can identify the user.

The control unit 17 can be configured to include at least one processor, at least one specialized circuit, or a combination of these. The processor is a general-purpose processor, such as a central processing unit (CPU)), a graphics processing unit (GPU), or the like, or a specialized processor specialized in specific processing. The specialized circuit is, for example, a field-programmable gate array (FPGA), an application specific integrated circuit (ASIC), or the like. The control unit 17 can execute the processing related to the operation of the vehicle 10, while controlling each unit of the vehicle 10. The control unit 17 may have a clocking function to acquire the current time.

The functions of the vehicle 10 may be implemented by executing a control program according to the present embodiment by a processor corresponding to the control unit 17. In other words, the functions of the vehicle 10 may be implemented by software. The control program enables a computer to function as the vehicle 10 by causing the computer to execute operation of the vehicle 10. In other words, the computer can function as the vehicle 10 by executing the operation of the vehicle 10 in accordance with the control program.

In the present disclosure, the “program” can be recorded in a computer readable non-transitory recording medium. For example, the computer readable non-transitory recording medium is a magnetic recording medium, an optical disc, a magneto-optical recording medium, or a ROM. For example, the program may be distributed by selling, transferring or lending a portable recording medium, such as a digital versatile disc (DVD), or a compact disc read only memory (CD-ROM), having the program recorded therein. The program may be stored in a storage of a server. The program stored in the storage of the server may be distributed through transfer to other computers. The program may be provided as a program product.

In the present disclosure, the “computer” can temporarily store in a main storage a program recorded in a portable recording medium or a program transferred from the server, for example. The computer can further read a program stored in the main storage by a processor, and can execute processing in accordance with the read program by the processor. The computer may read a program directly from a portable recording medium, and may execute processing in accordance with the program. Whenever a program is transferred to the computer from a server, the computer may execute the processing in accordance with the received program in sequence. The computer may execute the processing by what is called an application service provider (ASP) service which implements the functions only through execution instructions and result acquisition, without through transfer of the program from the server to the computer. The program may include those equivalent to the program which is information used for processing by an electronic calculator. For example, the data which does not constitute direct instructions to the computer although having the property of defining the process of the computer corresponds to “those equivalent to the program”.

One, some, or all of the functions of the vehicle 10 may be implemented by a specialized circuit corresponding to the control unit 17. In short, one, some, or all of the functions of the vehicle 10 may be implemented by hardware.

The control unit 17 can receive an input to indicate the position of the first shop 3 as a destination and an input to instruct route search with the input unit 14. The control unit 17 can receive from the input unit 14 an input to indicate a departure time. The user X can make these inputs with the input unit 14 when the user X boards the vehicle 10 and departs for the first shop 3. Upon reception of these inputs, the control unit 17 can acquire current position information on the vehicle 10 by the positioning unit 13. The control unit 17 can search for a route from a place of departure to a destination based on the departure time, the current position of the vehicle 10 as a place of departure, the position of the first shop 3 as a destination, and road map information in the storage unit 16. The control unit 17 may search for the route from the place of departure to the destination with optional route search algorithms. The control unit 17 may search for the shortest route that is shortest in distance, out of the routes from the place of departure to the destination, depending on settings of the control device 11 or the like. The control unit 17 may search for the fastest route that enables the user to arrive at the destination fastest, out of the routes from the place of departure to the destination, depending on the settings of the control device 11, or the like. Hereinafter, the routes from the place of departure to the destination searched by the control unit 17 are stated as “search routes”. The control unit 17 can generate route information, when a route from the place of departure to the destination is searched.

The route information may include at least search route information or information on an estimated time of arrival. The estimated time of arrival is an estimated time of arrival at the destination. The search route may include at least one place that is associated with information on an estimated travel time that is the time when the vehicle 10 is estimated to travel at the place. The control unit 17 can calculate the estimated time of arrival and the estimated travel time based on the search route. The route information may include, in addition to the search route information and the like, optional information used for search of the search route. Examples of the optional information include information on the route search algorithm used for search of the search route.

The control unit 17 can output the route information from the output unit 15. Since the route information is output from the output unit 15, the user X can recognize the route information. Referring to the route information, the user X drives the vehicle 10 and heads for the first shop 3.

The control unit 17 can transmit the route information, together with the identification information on the user X, to the information processing device 40 through the network 2 with the communication unit 12.

The control unit 17 can acquire the position information on the vehicle 10 with the positioning unit 13 while the vehicle 10 travels. The control unit 17 may acquire by the clocking function of the control unit 17 the time when the position information on the vehicle 10 is acquired. Hereinafter, the time when the position information on the vehicle 10 is acquired is also stated as “movement time”. The control unit 17 can transmit the position information on the vehicle 10 and the movement time of the vehicle 10, together with the identification information on the user X, to the information processing device 40 through the network 2 with the communication unit 12. The control unit 17 may acquire the position information on the vehicle 10 and the movement time of the vehicle 10 at any time intervals, and may transmit the position information on the vehicle 10 and the movement time of the vehicle 10 to the information processing device 40 together with the identification information on the user X. The time intervals may be set in advance based on an average speed of the vehicle 10, or properly be changed in accordance with the speed of the vehicle 10. In the case of properly changing the time intervals, when the speed of the vehicle 10 is high, the control unit 17 may change the time intervals to be shorter than when the speed of the vehicle 10 is low.

As shown in FIG. 2, the terminal device 20 includes a communication unit 21, an input unit 22, an output unit 23, a storage unit 24, and a control unit 25.

The communication unit 21, like the communication unit 12, can be configured to include at least one communication module connectable with the network 2.

The input unit 22 can receive input from a user. The input unit 22, like the input unit 14, can be configured to include at least one input interface which can receive input from the user.

The output unit 23 can output data. Like the output unit 15, the output unit 23 can be configured to include at least one output interface which can output data.

The storage unit 24, like the storage unit 16, can be configured to include at least one semiconductor memory, at least one magnetic memory, at least one optical memory, or a combination of at least two types of these memories. The storage unit 24 may function as a main storage, an auxiliary storage, or a cache memory. The storage unit 24 stores data used for operation of the terminal device 20, and data obtained by operation of the terminal device 20.

The storage unit 24 stores, for example, identification information on the user of the terminal device 20. The identification information on the user of the terminal device 20 may be any information which can identify the user of the terminal device 20. The storage unit 24 of the terminal device 20A stores, for example, identification information on the user A as the identification information on the user of the terminal device 20. The storage unit 24 of the terminal device 20B stores, for example, identification information on the user B as the identification information on the user of the terminal device 20.

The control unit 25, like the control unit 17, can be configured to include at least one processor, at least one specialized circuit, or a combination of these. The control unit 25 can execute processing related to the operation of the terminal device 20, while controlling each unit of the terminal device 20.

The function of the terminal device 20 can be implemented by executing a first terminal program according to the present embodiment by a processor corresponding to the control unit 25. In other words, the function of the terminal device 20 can be implemented by software. The first terminal program enables a computer to function as the terminal device 20 by causing the computer to execute operation of the terminal device 20. In other words, the computer can function as the terminal device 20 by executing the operation of the terminal device 20 in accordance with the first terminal program.

One, some, or all of the functions of the terminal device 20 may be implemented by a specialized circuit corresponding to the control unit 25. In short, one, some, or all of the functions of the terminal device 20 may be implemented by hardware.

The control unit 25 can receive with the input unit 22 an input to apply reservation of the first shop 3 and an input indicating a reservation frame that the user wants to reserve. The user who wants to reserve a reservation frame of the first shop 3 can make these inputs from the input unit 22. Upon reception of these inputs with the input unit 22, the control unit 25 generates application information. The application information includes, for example, the identification information on the user of the terminal device 20 and information indicating the reservation frame that the user wants to reserve. The control unit 25 can transmit the application information to the information processing device 40 through the network 2 with the communication unit 21. After transmitting the application information, the control unit 25 can receive a notification indicating that the reservation is registered or a notification of waiting for cancellation from the information processing device 40 via the network 2 with the communication unit 21. The control unit 25 can output the received notification from the output unit 23.

As shown in FIG. 2, the terminal device 30 includes a communication unit 31, an input unit 32, an output unit 33, a storage unit 34, and a control unit 35.

The communication unit 31 can be configured to include at least one communication module connectable with the network 2. For example, the communication module conforms to communications standards, such as local area network (LAN) or wireless LAN communications standards. The communication unit 31 can be connected to the network 2 through a wired LAN or wireless LAN with use of the communication module.

The input unit 32 can receive input from a user. The input unit 32, like the input unit 14, can be configured to include at least one input interface which can receive input from the user.

The output unit 33 can output data. Like the output unit 15, the output unit 33 can be configured to include at least one output interface which can output data.

The storage unit 34, like the storage unit 16, can be configured to include at least one semiconductor memory, at least one magnetic memory, at least one optical memory, or a combination of at least two types of these memories. The storage unit 34 may function as a main storage, an auxiliary storage, or a cache memory. The storage unit 34 stores data used for operation of the terminal device 30, and data obtained by operation of the terminal device 30.

The control unit 35, like the control unit 17, can be configured to include at least one processor, at least one specialized circuit, or a combination of these. The control unit 35 can execute processing related to the operation of the terminal device 30, while controlling each unit of the terminal device 30.

The function of the terminal device 30 can be implemented by executing a second terminal program according to the present embodiment by a processor corresponding to the control unit 35. In other words, the function of the terminal device 30 can be implemented by software. The second terminal program enables a computer to function as the terminal device 30 by causing the computer to execute operation of the terminal device 30. In other words, the computer can function as the terminal device 30 by executing the operation of the terminal device 30 in accordance with the second terminal program.

One, some, or all of the functions of the terminal device 30 may be implemented by a specialized circuit corresponding to the control unit 35. In short, one, some, or all of the functions of the terminal device 30 may be implemented by hardware.

The processing of the control unit 35 will be described later.

As shown in FIG. 2, the information processing device 40 includes a communication unit 41, a storage unit 42, and a control unit 43.

The communication unit 41, like the communication unit 31, can be configured to include at least one communication module connectable with the network 2. The communication unit 41, like the communication unit 31, can be connected to the network 2 through a wired LAN or a wireless LAN with use of a communication module that conforms to standards, such as wired LAN and wireless LAN standards.

The storage unit 42, like the storage unit 16, can be configured to include at least one semiconductor memory, at least one magnetic memory, at least one optical memory, or a combination of at least two types of these memories. The storage unit 42 may function as a main storage, an auxiliary storage, or a cache memory. The storage unit 42 stores data used for operation of the information processing device 40, and data obtained by operation of the information processing device 40.

The storage unit 42 stores, for example, road map information. The road map information stored in the storage unit 42 may be the same as the road map information stored in the storage unit 16.

The storage unit 42 stores, for example, information on terminal devices that are associated with the identification information on reservers who have reserved reservation frames of the first shop 3. For example, the storage unit 42 store information on the control device 11 of the vehicle 10 as the terminal device that is associated with the identification information on the user X who is a reserver of a reservation frame 50 described later. For example, the storage unit 42 stores information on the terminal device 20B that is associated with the identification information on the user B who is a reserver of a reservation frame 55 described later. For example, the storage unit 42 stores information on a terminal device that is associated with the identification information on the reserver of a reservation frame 56 described later and information on a terminal device that is associated with the identification information on the reserver of a reservation frame 57 described later.

The storage unit 42 stores, for example, information on terminal devices that are associated with the identification information on users who are waiting for cancellation of the reservation frames of the first shop 3. For example, the storage unit 42 stores information on the terminal device 20B that is associated with the identification information on the user A who is waiting for cancellation of the reservation frame 50 described later.

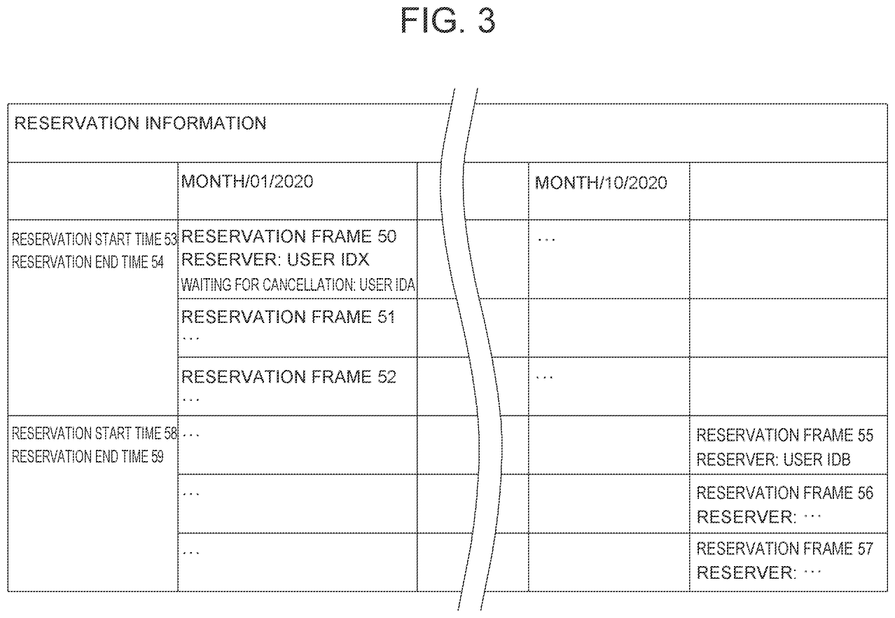

The storage unit 42 stores, for example, reservation information on optional shops. For example, the storage unit 42 stores reservation information on the first shop 3 as shown in FIG. 3. The reservation frames 50, 51, 52, 55, 56, 57 are reservation frames already reserved.

The reservation frames 50, 51, 52 are in a time period from a reservation start time 53 to a reservation end time 54 on Month/01/2020. The reservation frame 50 is associated with a user IDX as identification information on the reserver who has reserved the reservation frame 50. The user IDX is the identification information on the user X. The reservation frame 50 is also associated with a user IDA as identification information on the user who is waiting for cancellation of the reservation frame 50. The user IDA is the identification information on the user A.

The reservation frames 55, 56, 57 are in a time period from a reservation start time 58 to a reservation end time 59 on Month/10/2020. The reservation frame 55 is associated with a user IDB as identification information on the reserver who has reserved the reservation frame 55. The user IDB is the identification information on the user B.

The control unit 43, like the control unit 17, can be configured to include at least one processor, at least one specialized circuit, or a combination of these. The control unit 43 can execute the processing related to the operation of the information processing device 40, while controlling each unit of the information processing device 40.

The functions of the information processing device 40 can be implemented by executing a processing program according to the present embodiment by a processor corresponding to the control unit 43. In other words, the functions of the information processing device 40 may be implemented by software. The processing program enables a computer to function as the information processing device 40 by causing the computer to execute the operation of the information processing device 40. In other words, the computer can function as the information processing device 40 by executing the operation of the information processing device 40 in accordance with the processing program.

One, some, or all of the functions of the information processing device 40 may be implemented by a specialized circuit corresponding to the control unit 43. In short, one, some, or all of the functions of the information processing device 40 may be implemented by hardware.

The control unit 43 can receive application information from the terminal device 20 through the network 2 with the communication unit 41. The control unit 43 can determine whether or not the reservation frame that the user of the terminal device 20 wants to reserve is available, based on the received application information and the reservation information for the first shop 3 stored in the storage unit 42. When the control unit 43 determines that the reservation frame is available, the control unit 43 associates the identification information on the user of the terminal device 20 with the reserver of the reservation frame in the reservation information for the first shop 3, and thereby the reservation of the user is registered. Once the reservation of the user is registered, the control unit 43 can transmit a notification of the registered reservation to the terminal device 20 through the network 2 with the communication unit 41. When the control unit 43 determines that the reservation frame is not available, the control unit 43 transmits a notification of waiting for cancellation to the terminal device 20 through the network 2 with the communication unit 41. In this case, the control unit 43 may associate the reservation frame in the reservation information for the first shop 3 with the identification information on the user as the identification information on the user waiting for cancellation.

The control unit 43 can receive route information, together with the identification information on the user X, from the vehicle 10 through the network 2 with the communication unit 41. The control unit 43 can receive these pieces of information when the vehicle 10 departs for the first shop 3. The route information can be used as information that is searched in advance with the first shop 3 as a destination. The control unit 43 can store in the storage unit 42 the route information associated with the identification information on the user X. Hereinafter, the route information received together with the identification information on the user X from the vehicle 10 is also stated as “route information related to the user X”.

The control unit 43 can receive information on the position and movement time of the vehicle 10, together with the identification information on the user X, from the vehicle 10 through the network 2 with the communication unit 41. The control unit 43 can receive these pieces of information, after the vehicle 10 departs for the first shop 3. The control unit 43 can sequentially receive the information on the position and movement time of the vehicle 10 that are variable as the vehicle 10 travels, together with the identification information on the user X. The control unit 43 stores in the storage unit 42 the information on the position and movement time of the vehicle 10 and the identification information on the user X received in sequence as the movement information on the user X. The movement information on the user X may include information on the moving route and information on the movement time of the user X. The moving route can be a set of the position information on the vehicle 10. Each piece of position information on the vehicle 10 as the moving route may also be associated with the movement time that is received together with the position information.

Determination Processing

The control unit 43 can execute determination processing for determining whether or not the user X can arrive at the first shop 3 by a first time. The first time may be set based on the reservation start time 53. The first time may be the same as the reservation start time 53, or may be a time t1 after the reservation start time. The time t1 may be a delay time that the first shop 3 allows.

### Example 1

The control unit 43 may execute the determination processing by an optional method based on the movement information on the user X. As an example, the control unit 43 may determine, based on the movement information on the user X, whether or not the user X can arrive at the first shop 3 by the first time by searching for a route to the first shop 3 as a destination. In this case, the control unit 43 may acquire, from the movement information on the user X, an optional movement time and the position information on the vehicle 10 associated with the optional movement time. The control unit 43 may search for the route from the position of the vehicle 10 to the first shop 3 as a destination, based on the movement time acquired as the departure time, the position of the vehicle 10 acquired as a place of departure, the position of the first shop 3 as a destination, and the road map information in the storage unit 42. The control unit 43 may calculate the estimated time of arrival at the first shop 3 as a destination, based on the searched route. When the calculated estimated time of arrival is the same as the first time or before the first time, the control unit 43 may determine that the user X is able to arrive at the first shop 3 by the first time. Meanwhile, when the calculated estimated time of arrival is after the first time, the control unit 43 may determine that the user X is unable to arrive at the first shop 3 by the first time.

The control unit 43 may also search for a route to the first shop 3 as a destination with use of the same route search algorithm as the route search algorithm used for search of the search route in the route information. As described above, the route information may include information on the route search algorithm used for search of the search route.

Note that the control unit 43 can execute the determination processing at the time that is a set time before the reservation start time 53 as will be described later. In this case, the control unit 43 may acquire, from the movement information on the user X, a movement time closer to the time that is the set time before the reservation start time 53 and the position information on the vehicle 10 associated with the movement time, and may search for the route to the first shop 3 as a destination as described above.

### Example 2

The control unit 43 may execute the determination processing by an optional method based on the route information related to the user X. As an example, when the estimated time of arrival in the route information related to the user X is after the first time, the control unit 43 may determine that the user X is unable to arrive at the first shop 3 by the first time.

Processing of Cancellation Notification

When the control unit 43 determines that the user X is unable to arrive at the first shop 3 by the first time, the control unit 43 may transmit a notification that the reservation of the first shop 3 is cancelled to the vehicle 10 through the network 2 with the communication unit 41. In the vehicle 10, the control unit 17 can receive the notification that the reservation of the first shop 3 is cancelled from the information processing device 40 through the network 2 with the communication unit 12. In the vehicle 10, the control unit 17 may output the notification that the reservation of the first shop 3 is cancelled from the output unit 15. With such configuration, the user X can know that the reservation of the first shop 3 is canceled.

When the control unit 43 determines that the user X is unable to arrive at the first shop 3 by the first time, the control unit 43 may transmit a notification that the reservation frame 50 is cancelled, together with the identification information on the user X, to the terminal device 30 of the first shop 3 through the network 2 with the communication unit 41. In the terminal device 30, the control unit 35 can receive the notification that the reservation frame 50 is cancelled, together with the identification information on the user X, from the information processing device 40 through the network 2 with the communication unit 31. In the terminal device 30, the control unit 35 may output the notification that the reservation frame 50 is cancelled, together with the identification information on the user X, from the output unit 33. With such configuration, a salesclerk of the first shop 3 can know that the user X cancels the reservation frame 50 of the first shop 3.

Processing of Cancellation Fee Determination

When the control unit 43 determines that the user X is unable to arrive at the first shop 3 by the first time, the control unit 43 can determine a cancellation fee based on the movement information on the user X. The control unit 43 may acquire the degree of deviation of the moving route in the movement information on the user X from the search route in the route information related to the user X. The control unit 43 may determine a cancellation fee based on the degree of deviation.

The degree of deviation may be an index indicating how much the moving route in the movement information on the user X deviates from the search route in the route information related to the user X. The degree of deviation may be given as a numerical value. In this case, the larger the numerical value is, the higher the degree of deviation may become. The degree of deviation may be given, for example, as optional levels such as three levels of “low”, “middle”, and “high”.

The control unit 43 may acquire the degree of deviation by calculating the degree of deviation by optional methods. As an example, the control unit 43 may calculate the degree of deviation by dividing the distance of the moving route in the movement information on the user X by the distance of the search route in the route information related to the user X. The moving route used for calculating the degree of deviation may be a route along which the vehicle 10 moves by the first time after the vehicle 10 departs.

Here, when a deviation rate is large, there is a high possibility that the user X does not drive the vehicle 10 along the search route in the route information. When the user X does not drive the vehicle 10 along the search route in the route information, there is a high possibility that the user X makes a detour or the like. Specifically, when the user X is unable to arrive at the first shop 3 by the first time with a large degree of deviation, there is a high possibility that the cause why the user X is unable to arrive at the first shop 3 by the first time, that is, the cause why the user X cancels the reservation of the first shop 3, is attributed to the action of the user X.

Meanwhile, when the deviation rate is small, there is a high possibility that the user X drives the vehicle 10 along the search route in the route information. When the user X drives the vehicle 10 driving along the search route but the user X is unable to arrive at the first shop 3 by the first time, there is a high possibility that the vehicle 10 is involved in troubles, such as traffic congestion. Specifically, when the user X is unable to arrive at the first shop 3 by the first time with a small deviation rate, there is a high possibility that the cause why the user X is unable to arrive at the first shop 3 by the first time, that is, the cause why the user X cancels the reservation of the first shop 3, is not attributed to the action of the user X.

When the degree of deviation is large, the control unit 43 may determine a higher cancellation fee than when the degree of deviation is small. With such configuration, the cancellation fee can be higher when the cause why reservation of the first shop 3 is cancelled is attributed to the action of the user X. When the degree of deviation is small, the control unit 43 may also determine a lower cancellation fee than when the degree of deviation is large. With such configuration, the cancellation fee can be lower when the cause why reservation of the first shop 3 is cancelled is not attributed to the action of the user X. The control unit 43 may also determine not to charge a cancellation fee, when the degree of deviation is smaller than a threshold. The threshold may be set as appropriate based on the degree of deviation when traffic congestion or the like occurs on the search route in the route information.

Processing of Notification of Cancellation Fee

The control unit 43 may transmit information on the cancellation fee to the vehicle 10 through the network 2 with the communication unit 41. When the control unit 43 determines that the cancellation fee is not charged, the control unit 43 may transmit to the vehicle 10 a notification that the cancellation fee is not charged through the network 2 with the communication unit 41. In the vehicle 10, the control unit 17 can receive from the information processing device 40 the information on the cancellation fee or the notification that the cancellation fee is not charged through the network 2 with the communication unit 12. In the vehicle 10, the control unit 17 may output the information on the cancellation fee or the notification that the cancellation fee is not charged from the output unit 15. With such configuration, the user X can recognize the cancellation fee or the like.

The control unit 43 can transmit information on the cancellation fee, together with the identification information on the user X, to the terminal device 30 of the first shop 3 through the network 2 with the communication unit 41. When the control unit 43 determines that the cancellation fee is not charged, the control unit 43 may transmit the notification that the cancellation fee is not charged, together with the identification information on the user X, to the terminal device 30 of the first shop 3 through the network 2 with the communication unit 41. In the terminal device 30, the control unit 35 can receive from the information processing device 40 the information on the cancellation fee or the notification that the cancellation fee is not charged, together with the identification information on the user X, through the network 2 with the communication unit 31. In the terminal device 30, the control unit 35 may output the information on the cancellation fee or the notification that the cancellation fee is not charged, together with the identification information on the user X, from the output unit 33. With such configuration, the salesclerk of the first shop 3 can recognize the cancellation fee of the user X or the like.

The control unit 43 may transmit the information on the cancellation fee, together with the identification information on the user X and the identification information on the first shop 3, to an external server through the network 2 with the communication unit 41. The external server may mediate transactions of money, or the like, between the first shop 3 and the user X. Note that the user X may pay the cancellation fee directly to the first shop 3.

Processing of Offering Reservation Frame

When the control unit 43 determines that the user X is unable to arrive at the first shop 3 by the first time, the control unit 43 may transmit to a terminal device set in advance a notification to offer a reservation frame 50 corresponding to a reservation start time 53 with the communication unit 41. Hereinafter, the terminal device to which the control unit 43 transmits the notification to offer the reservation frame 50 is also stated as a “transmission destination”. The transmission destination may be set as appropriate as in the example shown below.

### Example 1

The transmission destination may be the terminal device 20A that is associated with the identification information on the user A who is waiting for cancellation of the reservation frame 50. In this case, the control unit 43 may identify the identification information on the user A waiting for cancellation of the reservation frame 50 based on the reservation information for the first shop 3 in the storage unit 42, and may acquire the information on the terminal device 20A that is associated with the identification information on the user A from the storage unit 42. The control unit 43 may transmit a notification to offer the reservation frame 50 to the terminal device 20A through the network 2 with the communication unit 41.

In the terminal device 20A, the control unit 25 can receive the notification to offer the reservation frame 50 from the information processing device 40 through the network 2 with the communication unit 21. The control unit 25 may output the notification to offer the reservation frame 50 from the output unit 23. Since the notification to offer the reservation frame 50 is output from the output unit 23, the user A can determine whether or not to reserve the reservation frame 50. When the user A determines to reserve the reservation frame 50, the user A can make an input indicating reservation of the reservation frame 50 from the input unit 22. When the control unit 25 receives the input indicating reservation of the reservation frame 50 from the input unit 22, the control unit 25 may transmit a notification of reserving the reservation frame 50 to the information processing device 40 through the network 2 with the communication unit 41. Meanwhile, when the user A determines not to reserve the reservation frame 50, the user A can make an input indicating not to reserve the reservation frame 50 from the input unit 22. When the control unit 25 receives the input indicating not to reserve the reservation frame 50 from the input unit 22, the control unit 25 may transmit a notification of not reserving the reservation frame 50 to the information processing device 40 through the network 2 with the communication unit 41.

The control unit 43 can receive the notification of reserving the reservation frame 50 from the terminal device 20A through the network 2 with the communication unit 41. In this case, the control unit 43 may transmit to the terminal device 30 of the first shop 3 a notification that the user A reserves the reservation frame 50, together with the identification information on the user A, through the network 2 with the communication unit 41. In the terminal device 30, the control unit 35 can receive from the information processing device 40 the notification that the user A reserves the reservation frame 50, together with the identification information on the user A, through the network 2 with the communication unit 31. In the terminal device 30, the control unit 35 may output the notification that the user A reserves the reservation frame 50, together with the identification information on the user A, from the output unit 33. With such configuration, the salesclerk of the first shop 3 can know that the reservation frame 50 is reserved by the user A. When the control unit 43 receives the notification of reserving the reservation frame 50 from the terminal device 20A, the control unit 43 may update the reservation information for the first shop 3 based on the notification as shown in FIG. 3.

With such configuration, the user A who is waiting for cancellation of the reservation frame 50 can reserve the reservation frame 50. Since the user A reserves the reservation frame 50, the possibility that the reservation frame 50 is unoccupied may be reduced. Since the possibility that the reservation frame 50 is unoccupied is reduced, it is possible to reduce loss of the first shop 3.

Meanwhile, the control unit 43 can also receive the notification of not reserving the reservation frame 50 from the terminal device 20A through the network 2 with the communication unit 41. In this case, the control unit 43 may execute processing of Example 2 shown below.

### Example 2

The transmission destination may be a terminal device associated with identification information on a user who has reserved in the first shop 3 at least any one of reservation frames that are in reservation time periods where the number of reserved reservation frames is equal to or more than a reference number. The reference number may be set as appropriate in accordance with the reservation status of the first shop 3. The control unit 43 may identify the reservation time period with reference to the reservation information for the first shop 3 as shown in FIG. 3. Hereinafter, the reference number is three. In this case, since three reservation frames 55, 56, 57 are already reserved in the reservation time period, the control unit 43 can determine that the number of the reserved reservation frames is equal to or more than the reference number. The control unit 43 can identify the time period from the reservation start time 58 to the reservation end time 59 as the reservation time period. The control unit 43 may select as a transmission destination the terminal device 20B that is associated with the identification information on the user B who has reserved the reservation frame 55. The control unit 43 may acquire the information on the terminal device 20B that is associated with the identification information on the user B from the storage unit 42. The control unit 43 may transmit to the terminal device 20B a notification to offer the reservation frame 50 through the network 2 with the communication unit 41.

In the terminal device 20B, the control unit 25 can receive the notification to offer the reservation frame 50 from the information processing device 40 through the network 2 with the communication unit 21. Upon reception of the notification, the control unit 25 may output the notification to offer the reservation frame 50 from the output unit 23. When the notification is output from the output unit 23, the user B can determine whether or not to change reservation from the reserved reservation frame 55 to the reservation frame 50.

When the user B determines to change reservation from the reservation frame 55 to the reservation frame 50, the user B can make an input indicating change of reservation from the reservation frame 55 to the reservation frame 50 from the input unit 22. When the control unit 25 receives the input from the input unit 22, the control unit 25 may transmit a notification of changing reservation from the reservation frame 55 to the reservation frame 50 to the information processing device 40 through the network 2 with the communication unit 21. Meanwhile, when the user B determines not to change reservation from the reservation frame 55 to the reservation frame 50, the user B can make an input indicating no change of reservation from the reservation frame 55 to the reservation frame 50 from the input unit 22. When receiving the input from the input unit 22, the control unit 25 may transmit a notification of no reservation change from the reservation frame 55 to the reservation frame 50 to the information processing device 40 through the network 2 with the communication unit 41.

The control unit 43 can receive from the terminal device 20B the notification of changing reservation from the reservation frame 55 to the reservation frame 50 through the network 2 with the communication unit 41. In this case, the control unit 43 may transmit a notification that the user B changes reservation from the reservation frame 55 to the reservation frame 50, together with the identification information on the user B, to the terminal device 30 of the first shop 3 through the network 2 with the communication unit 41. In the terminal device 30, the control unit 35 can receive from the information processing device 40 the notification that the user B changes reservation from the reservation frame 55 to the reservation frame 50, together with the identification information on the user B, through the network 2 with the communication unit 31. In the terminal device 30, the control unit 35 may output the notification that the user B changes reservation from the reservation frame 55 to the reservation frame 50, together with the identification information on the user B, from the output unit 33. With such configuration, the salesclerk of the first shop 3 can know that the user B has changed reservation from the reservation frame 55 to the reservation frame 50.

Thus, when the user B changes reservation from the reservation frame 55 to the reservation frame 50, the possibility that the reservation frame 50 is unoccupied is reduced. Since the possibility that the reservation frame 50 is unoccupied is reduced, it is possible to reduce loss of the first shop 3. Moreover, since the user B changes reservation from the reservation frame 55 to the reservation frame 50, the reservation frame 55 is put in an unoccupied state, that is, the reservation frame 55 is put in an available state. Here, it is highly likely that the reservation time period where the number of reservations is equal to or more than the reference number is a popular reservation time period in the first shop 3. Even when the reservation frame 55 that is the reservation time period popular in the first shop 3 is unoccupied, it is highly likely that the reservation frame 55 is immediately reserved by another user. With such configuration, it is possible to reduce loss of the first shop 3 more.

When the control unit 43 receives from the terminal device 20B the notification of changing reservation from the reservation frame 55 to the reservation frame 50 with the communication unit 41, the control unit 43 may update the reservation status of the first shop 3 as shown in FIG. 3 based on the notification.

When the control unit 43 receives from the terminal device 20B the notification of changing reservation from the reservation frame 55 to the reservation frame 50 with the communication unit 41, the control unit 43 may determine to grant a reward to the user B of the terminal device 20B. The reward may be set in advance by the first shop 3 or the like. For example, the reward is a discount of the use fee in the first shop 3. When the control unit 43 determines to grant a reward to the user B, the control unit 43 may transmit a notification of determining that a reward is granted to the user B, together with the identification information on the user B, to the terminal device 30 of the first shop 3 through the network 2 with the communication unit 41. In the terminal device 30, the control unit 35 can receive from the information processing device 40 the notification of determining that a reward is granted to the user B, together with the identification information on the user B, through the network 2 with the communication unit 31. In the terminal device 30, the control unit 35 may output the notification of determining that a reward is granted to the user B, together with the identification information on the user B, from the output unit 33. When the notification of determining that a reward is granted to the user B is output together with the identification information on the user B from the output unit 33, the salesclerk of the first shop 3 can know that the reward is determined to be granted to the user B.

When such a reward is granted, the possibility that the user B changes reservation from the reservation frame 55 to the reservation frame 50 may increase. The control unit 43 may also transmit to the terminal device 20B a notification that a reward is granted if reservation is changed from the reservation frame 55 to the reservation frame 50, together with the notification to offer the reservation frame 50. In this case, in the terminal device 20B, the control unit 25 can receive from the information processing device 40 the notification that a reward is granted if reservation is changed from the reservation frame 55 to the reservation frame 50, together with the notification to offer the reservation frame 50 through the network 2 with the communication unit 21. In the terminal device 20B, upon reception of these notifications, the control unit 25 may output the notification that a reward is granted if reservation is changed from the reservation frame 55 to the reservation frame 50, together with the notification to offer the reservation frame 50 from the output unit 23. When the notification that a reward is granted if reservation is changed from the reservation frame 55 to the reservation frame 50, or other notifications, are output from the output unit 23, the possibility that the user B determines to change reservation from the reserved reservation frame 55 to the reservation frame 50 may increase.

Meanwhile, the control unit 43 can receive from the terminal device 20B the notification of not changing reservation from the reservation frame 55 to the reservation frame 50 through the network 2 with the communication unit 41. In this case, the control unit 43 may transmit the notification to offer the reservation frame 50 to a terminal device that is associated with the identification information on a user who has reserved another reservation frame 56 or 57 in the reservation time period from the reservation start time 58 to the reservation end time 59 with the communication unit 41.

Here, the control unit 43 may execute the determination processing at the time that is set time before the reservation start time 53. With such configuration, when the control unit 43 determines in the determination processing that the user X is unable to arrive at the first shop 3 by the first time, the control unit 43 can transmit to a transmission destination the notification to offer the reservation frame 50 at the time that is before the reservation start time 53 with the communication unit 41. By transmitting the notification to offer the reservation frame 50 to the transmission destination at the time before the reservation start time 53, a user that is the transmission destination, such as the user A or the user B, can secure the time of moving to the first shop 3. The set time may be set as appropriate based on the movement time for the user that is the transmission destination to move to the first shop 3. For example, when it is assumed that the user that is the transmission destination moves by a vehicle, the set time may be set as appropriate based on the traffic information around the first shop 3. In this case, the control unit 43 may acquire complexity that indicates the degree of complexity of road structure around the first shop 3 based on the traffic information around the first shop 3. The complexity may be given as a numerical value. In this case, the larger the numerical value is, the higher the complexity may become. The complexity may be given, for example, as optional levels such as three levels of “low”, “middle”, and “high”. When the complexity is high, the control unit 43 may set the set time to be longer than when the complexity is low.

Processing of Offering Second Shop

When the control unit 43 determines that the user X is unable to arrive at the first shop 3 by the first time, the control unit 43 may transmit a notification to offer a second shop 4 to the terminal device that is associated with the identification information on the user X with the communication unit 41. In the present embodiment, the control unit 43 can acquire from the storage unit 42 information on the control device 11 of the vehicle 10 as a terminal device that is associated with the identification information on the user X. In the present embodiment, the control unit 43 may transmit the notification to offer the second shop 4 to the control device 11 as a terminal device that is associated with the identification information on the user X, i.e., the vehicle 10, through the network 2.

The control unit 43 may acquire the position of the user X, and may determine a shop located within a preset range from the position of the user X as the second shop 4. The range may be a range where the vehicle 10 is movable from the current position within reference time. The reference time may be set as appropriate in accordance with the user X. For example, the reference time is 30 minutes. The control unit 43 may acquire, as the position information on the user X, the latest position information on the vehicle 10 in the movement information on the user X. The control unit 43 may determine the second shop 4 based on the position information on the user X, and the road map information in the storage unit 42.

The control unit 43 can identify a plurality of shops positioned within a preset range from the position of the user A. In this case, the control unit 43 may refer to the reservation information for a shop or shops stored in the storage unit 42, out of the identified shops, and may determine as the second shop 4 a shop having an available reservation frame in the time period after the lapse of the reference time from the current time. The control unit 43 may transmit to the vehicle 10 information on the available reservation frames of the second shop 4, together with the notification to offer the second shop 4.

In the vehicle 10, the control unit 17 can receive the notification to offer the second shop 4, or other notifications, from the information processing device 40 through the network 2 with the communication unit 12. The control unit 17 may output the notification to offer the second shop 4, or other notifications, from the output unit 15. With such configuration, the user A can know the presence of the second shop 4.

Operation of Information Processing System

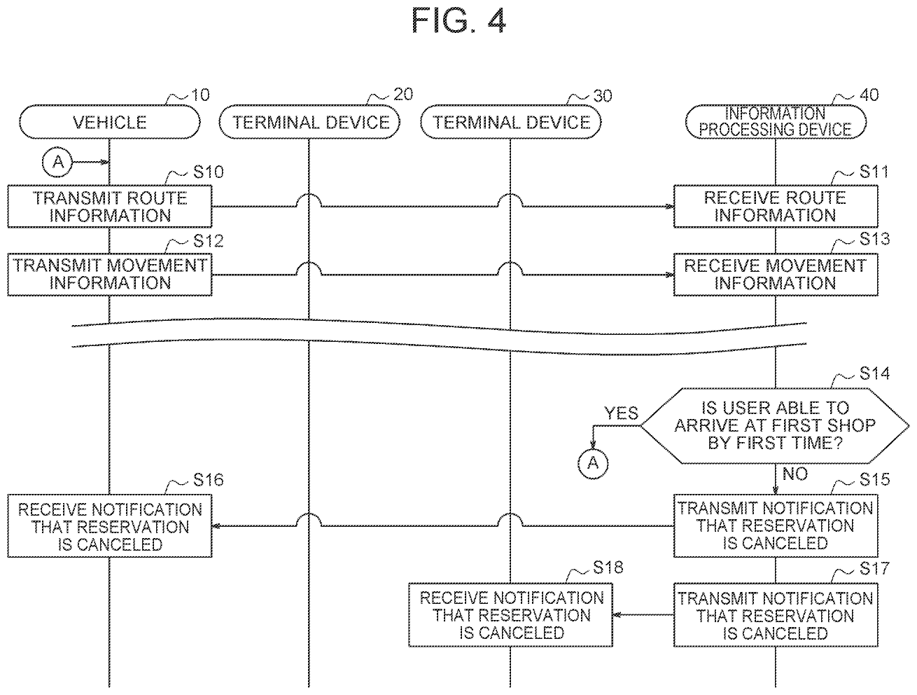

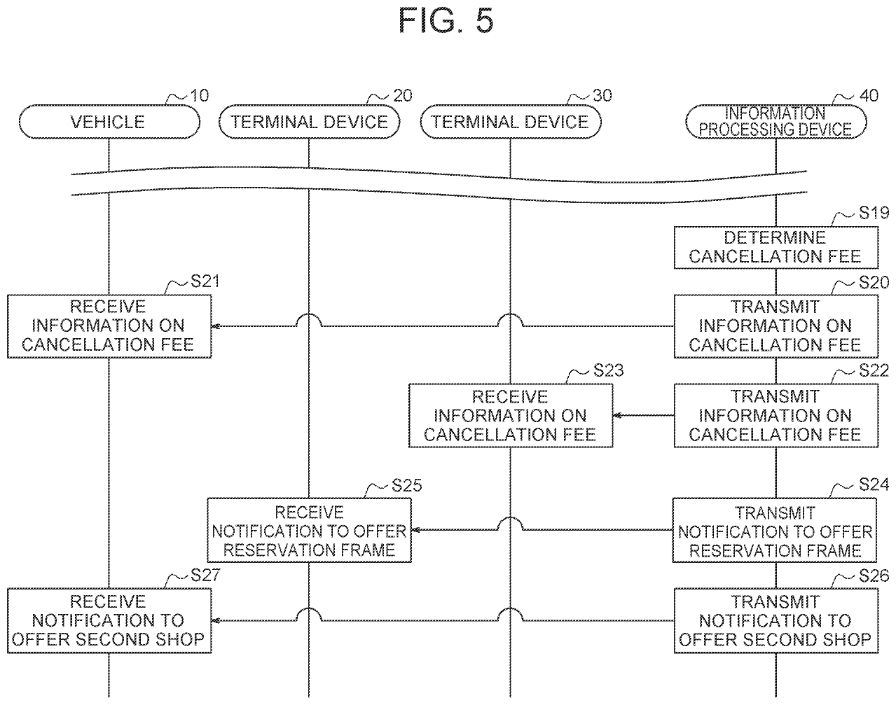

With reference to FIGS. 4 and 5, the operation of the information processing system 1 as shown in FIG. 1 will be described. The operation corresponds to an example of the method of information processing according to the present embodiment. For example, in the information processing system 1, when the control unit 17 of the vehicle 10 searches for a route from the current position of the vehicle 10 as a place of departure to the position of the first shop 3 as a destination, the control unit 17 executes the processing of step S10 as shown in FIG. 4.

In the vehicle 10, the control unit 17 transmits route information related to the user X, together with the identification information on the user X, to the information processing device 40 through the network 2 with the communication unit 12 (step S10). In the information processing device 40, the control unit 43 receives the identification information on the user X and the route information related to the user X from the vehicle 10 through the network 2 with the communication unit 41 (step S11).

In the vehicle 10, during travel of the vehicle 10, the control unit 17 transmits the position information on the vehicle 10 and movement time of the vehicle 10 together with the identification information on the user X to the information processing device 40 through the network 2 with the communication unit 12 (step S12). In the information processing device 40, the control unit 43 receives the position information on the vehicle 10, the movement time of the vehicle 10, and the identification information on the user X from the vehicle 10 through the network 2 with the communication unit 41 (step S13). The control unit 43 stores, as the movement information on the user X, in the storage unit 42 the information on the position and movement time of the vehicle 10 and the identification information on the user X received in sequence as described above.

In the information processing device 40, the control unit 43 determines whether or not the user X is able to arrive at the first shop 3 by a first time (step S14). When the control unit 43 determines that the user X is unable to arrive at the first shop 3 by the first time (step S14: No), the processing proceeds to step S15. Meanwhile, when the control unit 43 determines that the user X is able to arrive at the first shop 3 by the first time (step S14: Yes), the information processing system 1 returns to the processing of step S10.

In the processing of step S15, in the information processing device 40, the control unit 43 transmits to the vehicle 10 a notification that the reservation of the first shop 3 is canceled through the network 2 with the communication unit 41. In the vehicle 10, the control unit 17 receives the notification that the reservation of the first shop 3 is cancelled from the information processing device 40 through the network 2 with the communication unit 12 (step S16).

In the information processing device 40, the control unit 43 transmits to the terminal device 30 of the first shop 3 the notification that the reservation frame 50 is canceled, together with the identification information on the user X, through the network 2 with the communication unit 41 (step S17). In the terminal device 30, the control unit 35 receives the notification that the reservation frame 50 is cancelled, together with the identification information on the user X, from the information processing device 40 through the network 2 with the communication unit 31 (step S18).

When the processing of step S18 is executed, the information processing system 1 shifts to the processing of step S19 as shown in FIG. 5.

In the information processing device 40, the control unit 43 determines a cancellation fee based on the movement information on the user X (step S19). In the information processing device 40, the control unit 43 transmits information on the cancellation fee to the vehicle 10 through the network 2 with the communication unit 41 (step S20). In the vehicle 10, the control unit 17 receives the information on the cancellation fee from the information processing device 40 through the network 2 with the communication unit 12 (step S21). In the information processing device 40, the control unit 43 transmits information on the cancellation fee, together with the identification information on the user X, to the terminal device 30 of the first shop 3 through the network 2 with the communication unit 41 (step S22). In the terminal device 30, the control unit 35 receives from the information processing device 40 the information on the cancellation fee, together with the identification information on the user X, through the network 2 with the communication unit 31 (step S23).

In the information processing device 40, the control unit 43 transmits a notification to offer the reservation frame 50 to the terminal device 20A (step S24). In the terminal device 20A, the control unit 25 receives the notification to offer the reservation frame 50 from the information processing device 40 through the network 2 with the communication unit 21 (step S25). In the information processing device 40, the control unit 43 transmits the notification to offer the second shop 4 to the vehicle 10 through the network 2 with the communication unit 41 (step S26). In the vehicle 10, the control unit 17 receives the notification to offer the second shop 4, or other notifications, from the information processing device 40 through the network 2 with the communication unit 12 (step S27).

Thus, in the present embodiment, when the control unit 43 of the information processing device 40 determines that the user X is unable to arrive at the first shop 3 by the first time, the control unit 43 of the information processing device 40 determines a cancellation fee based on the movement information on the user X. With such configuration, the cancellation fee can be higher when, for example, the cause why the reservation of the first shop 3 is cancelled is attributed to the action of the user X as described before. The cancellation fee can be lower when, for example, the cause why the reservation of the first shop 3 is cancelled is not attributed to the action of the user X as described before. Hence, according to the present disclosure, the cancellation fee can be determined in accordance with the cause why the user X has cancelled the reservation.

Furthermore, in the present embodiment, when the degree of deviation is small, the control unit 43 of the information processing device 40 can determine a cancellation fee to be lower than when the degree of deviation is large. With such configuration, the cancellation fee can be lower when the cause why the reservation of the first shop 3 is cancelled is not attributed to the action of the user X. Since the cancellation fee can be lower when the cause why the reservation of the first shop 3 is cancelled is not attributed to the action of the user X, the possibility that the user X is dissatisfied with the cancellation fee can be reduced. Since the possibility that the user X is dissatisfied with the cancellation fee can be reduced, it is possible to encourage the user X to make a reservation in the first shop 3, even when, for example, the first shop 3 is in an inconvenient location.

The present disclosure is not limited to the embodiments disclosed. For example, a plurality of blocks described in the block diagrams may be combined, or one block may be divided into a plurality of blocks. Instead of chronologically executing a plurality of steps stated in the flowchart in accordance with the description, the steps may be executed in parallel or in different order in accordance with the performance of the devices that execute the respective steps or in accordance with the need. Further modifications are possible without departing from the scope of the present disclosure.

For example, according to the embodiment disclosed, the first time can be the time that is the time t1 after the reservation start time. In this case, when the control unit 43 in the information processing device 40 determines that the user X can arrive at the first shop 3 by the first time, the control unit 43 may determine whether or not the user X will arrive at the first shop 3 at the time that is after the reservation start time 53. When the control unit 43 determines that the user X will arrive at the first shop 3 at the time after the reservation start time 53, the control unit 43 may transmit a notification that the user X is delayed to the terminal device 30 of the first shop 3, together with the identification information on the user X, through the network 2 with the communication unit 41. The control unit 43 may transmit the estimated time of arrival of the user X at the first shop 3, together with the identification information on the user X and the notification that the user X is delayed, to the terminal device 30 of the first shop 3. The control unit 43 can calculate the estimated time of arrival of the user X at the first shop 3 by executing search for a route from the position of the vehicle 10 to the first shop 3 as a destination as described above. In the terminal device 30 of the first shop 3, the control unit 35 can receive from the information processing device 40 the notification that the user X is delayed or other notifications, together with the identification information on the user X, through the network 2 with the communication unit 31. In the terminal device 30, the control unit 35 may output the notification that the user X is delayed or other notifications, together with the identification information on the user X, from the output unit 33. With such configuration, the salesclerk of the first shop 3 can know that the user X is delayed.

For example, according to the embodiment disclosed, the user X heads for the first shop 3 by the vehicle 10. However, the user X may head for the first shop 3 by optional movement means. Examples of the optional movement means include a train, a bus, and by foot. The user X may head for the first shop 3 by combining the optional movement means. For example, the user X heads for the first shop 3 by means of a combination of the vehicle 10, a train, and by foot. Here, when, for example, the user X goes to the first shop 3 by the movement means other than the vehicle 10, the control unit 43 in the information processing device 40 can receive the movement information on the user X and the route information related to the user X from a terminal device with the communication unit 41 through the network 2. The terminal device is a terminal device used by the user X, for example. In this case, the storage unit 42 of the information processing device 40 stores, for example, information on the terminal device that is associated with the identification information on the user X. The terminal device may be any device as long as it is connectable with the network 2. The terminal device may have the same configuration as the terminal device 20. The terminal device may have an application installed therein to enable the user to search for the route from the place of departure to the destination. The application may be configured to search for the route from the place of departure to the destination by combining optional movement means. In the case where the application is installed in the terminal device, the control unit of the terminal device can transmit the route information related to the user X to the information processing device 40 through the network 2 with use the communication unit of the terminal device. The terminal device may include a positioning unit having the same configuration as the positioning unit 13 of the vehicle 10. The control unit of the terminal device can transmit the position information on the terminal device acquired by the positioning unit of the terminal device, together with the identification information on the user X, to the information processing device 40 through the network 2 with the communication unit of the terminal device. When the control unit 43 of the information processing device 40 determines that the user X is unable to arrive at the first shop 3 by the first time, the control unit 43 may transmit a notification to offer the second shop 4 to the terminal device that is associated with the identification information on the user X with the communication unit 41.

What is claimed is:

1. An information processing device, comprising a control unit configured to execute determination processing to determine whether or not a user will arrive at a first shop by a first time that is set based on a reservation start time of the first shop, and determine a cancellation fee based on movement information on the user when it is determined that the user will not arrive at the first shop by the first time.

2. The information processing device according to claim 1, wherein the control unit executes the determination processing based on the movement information on the user.

3. The information processing device according to claim 1, wherein:
when the control unit determines that the user will not arrive at the first shop by the first time, the control unit is configured to
acquire a degree of deviation of a moving route in the movement information from a search route in route information, the search route being searched in advance with the first shop as a destination, and
determine, when the degree of deviation is large, the cancellation fee to be higher than when the degree of deviation is small.

4. The information processing device according to claim 1, further comprising a communication unit, wherein
when the control unit determines that the user will not arrive at the first shop by the first time, the control unit is configured to transmit a notification to offer a reservation frame corresponding to the reservation start time to a terminal device that is set in advance with the communication unit.

5. The information processing device according to claim 4, wherein the terminal device is a terminal device associated with identification information on a user waiting for cancellation of the reservation frame.

6. The information processing device according to claim 4, wherein the terminal device is a terminal device associated with identification information on a user who has reserved in the first shop at least any one of reservation frames that are in a reservation time period where the number of reserved reservation frames is equal to or more than a reference number.

7. The information processing device according to claim 6, wherein when the control unit receives from the terminal device a notification that a reservation is changed from the reservation frame in the reservation time period to a reservation frame corresponding to the reservation start time with the communication unit, the control unit is configured to determine to grant a reward to the user of the terminal device.

8. The information processing device according to claim 4, wherein when the control unit determines that the user will not arrive at the first shop by the first time, the control unit is configured to
acquire position information on the user, and
transmit a notification to offer a second shop located within a preset range from the position of the user to the terminal device that is associated with the identification information on the user who is determined not to arrive at the first shop by the first time, with the communication unit.

9. The information processing device according to claim 1, wherein the control unit executes the determination processing at a time that is a set time before the reservation start time.

10. An information processing system, comprising:
a vehicle; and
an information processing device including a control unit, the control unit being configured to
execute determination processing to determine whether or not a user of the vehicle will arrive at a first shop by a first time that is set based on a reservation start time of the first shop, and
determine a cancellation fee based on movement information on the user when it is determined that the user will not arrive at the first shop by the first time.

11. The information processing system according to claim 10, wherein the control unit of the information processing device executes the determination processing based on the movement information on the user.

12. The information processing system according to claim 10, wherein
when it is determined that the user will not arrive at the first shop by the first time, the control unit of the information processing device is configured to
acquire a degree of deviation of a moving route in the movement information from a search route in route information, the search route being searched in advance with the first shop as a destination, and
determine, when the degree of deviation is large, the cancellation fee to be higher than when the degree of deviation is small.

13. The information processing system according to claim 10, wherein:
when the control unit of the information processing device determines that the user will not arrive at the first shop by the first time, the control unit of the information processing device is configured to transmit a notification that reservation of the first shop is canceled to the vehicle with a communication unit of the information processing device; and
when the control unit of the vehicle receives the notification that the reservation of the first shop is canceled from the information processing device with a communication unit of the vehicle, the control unit of the vehicle outputs the notification that the reservation of the first shop is canceled from an output unit of the vehicle.

14. The information processing system according to claim 10, wherein:
the control unit of the information processing device is configured to transmit information on the cancellation fee to the vehicle with a communication unit of the information processing device; and
when the control unit of the vehicle receives the information on the cancellation fee from the information processing device with a communication unit of the vehicle, the control unit of the vehicle is configured to output the information on the cancellation fee from an output unit of the vehicle.

15. The information processing system according to claim 10, further comprising a terminal device of the first shop, wherein:
when the control unit of the information processing device determines that the user will not arrive at the first shop by the first time, the control unit of the information processing device is configured to transmit a notification that a reservation frame reserved by the user is cancelled, together with identification information on the user, to the terminal device of the first shop with a communication unit of the information processing device; and
when the control unit of the terminal device of the first shop receives the notification that the reservation frame is cancelled, together with the identification information on the user, from the information processing device with a communication unit of the terminal device, the control unit of the terminal device is configured to output the notification that the reservation frame is cancelled from an output unit of the terminal device together with the identification information on the user.

16. The information processing system according to claim 15, wherein:
the control unit of the information processing device is configured to transmit information on the cancellation fee, together with the identification information on the user, to the terminal device of the first shop with the communication unit of the information processing device; and
when the control unit of the terminal device of the first shop receives the information on the cancellation fee, together with the identification information on the user, from the information processing device with the communication unit of the terminal device, the control unit of the terminal device of the first shop outputs the information on the cancellation fee from the output unit together with the identification information on the user.

17. The information processing system according to claim 10, wherein:
when the control unit of the information processing device determines that the user will not arrive at the first shop by the first time, the control unit of the information processing device is configured to transmit a notification to offer a second shop located within a preset range from a position of the user to the vehicle with a communication unit of the information processing device; and
when the control unit of the vehicle receives the notification to offer the second shop from the information processing device with a communication unit of the vehicle, the control unit of the vehicle is configured to output the notification to offer the second shop from an output unit of the vehicle.

18. The information processing system according to claim 10, wherein the control unit of the information processing device executes the determination processing at a time that is a set time before the reservation start time, the set time being set in advance.

19. The information processing system according to claim 18, wherein the control unit of the information processing device sets the set time based on traffic information around the first shop.

20. A method of information processing, comprising:
an information processing device executing determination processing to determine whether or not a user will arrive at a first shop by a first time that is set based on a reservation start time of the first shop; and
the information processing device determining a cancellation fee based on movement information on the user when it is determined that the user will not arrive at the first shop by the first time.
